(19) United States
(12) Patent Application Publication
(10) Pub. No.: US 2002/0161912 A1
(43) Pub. Date: Oct. 31, 2002

(54) Ethernet cross point switch for connecting multiple network sections with different speeds within physical layer protocol

(76) Inventors: Silverio C. Vasquez, Westminster, CO (US); Jaan Raamot, Broomfield, CO (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/811,906

(22) Filed: Mar. 19, 2001

(51) Int. Cl. G06F 15/16

(52) U.S. Cl. 709/233; 709/228

(57) ABSTRACT

A method for communicating information between a plurality of local area network sections having different transmission speeds includes three steps. One step includes receiving, within the physical layer protocol, a packet that is transmitted from a source terminal in a source network section having a source transmission speed to a destination terminal in a destination network section having a destination transmission speed, the destination transmission speed differing from the source transmission speed. Another step involves determining the transmission speed for the destination terminal. The method further includes the step of re-transmitting, within the physical layer protocol, the received packet to the destination network section at the destination transmission speed.

### FIELD OF THE INVENTION

The present invention relates generally to a system and method for connecting multiple network sections within physical layer protocol, and more particularly, to a system and method for connecting multiple network sections which may have different transmission speeds within physical layer protocol.

### BACKGROUND OF THE INVENTION

Data networks, in general, use multiple layers of communication protocols to effectuate data communication between entities on the network. The lowest layer of the communication is often referred to as the physical layer. The second layer is often referred to as the packet layer. Communication standards that include such multiple layer connectivity include that defined in the ISO 8802/3IEEE 802.3 specification for 10Base-T local area networks.

In accordance with such communication schemes, lower layers are generally employed for local switching between the network entities connected to a single hub. In general, physical layer switches are geographically limited in part because of the methodologies employed to detect whether connectivity is available. According to the ISO standard, an source entity determines physical layer connectivity by sending a packet to the hub, the packet being intended for a destination entity. When the hub receives a transmit packet, it repeats the packet to all entities that are connected to the hub. If another network entity has transmitted a packet to the hub before the packet from the source hub is completely received by the hub, the source entity detects a collision and then determines that the transmission is unsuccessful. If however, no collision is detected, the hub provides the connection to the destination entity and passes the transmitted packet directly through.

Packet layer switching, which typically occurs between hubs of a larger network, includes the step of sending one or more packets to a packet switch from a source entity. The packet switch then stores (or holds) one or more packets and transmits the packets when connectivity to the destination entity or another intermediate switch is available. By contrast, in physical layer switching, as discussed above, the collision is made in real-time as the source entity packet is being transmitted.

Accordingly, physical layer switching allows for faster communication than packet layer switching because physical layer switching does not involve the storage of packets in the intermediate switch. However, packet layer switching is usually required to establish connectivity between multiple local area networks (“LANs”). Thus, communication between entities on multiple local area networks is relatively slow as compared to communication between entities on the same local area network.

A switching system has been proposed, however, that allows multiple LANs to be connected at physical layer, thus providing increased communication speed. The switching system is described in U.S. patent application Ser. No. 09/203,012, filed Nov. 30, 1998, which is assigned to the assignee of the present invention and incorporated herein by reference. The system includes a space switching unit and a plurality of switch interface units coupled between the space switching unit and a plurality of LANs. When a LAN provides a transmit packet to its switch interface unit, the switch interface unit establishes a first unilateral path from the destination entity to the switch interface unit that is coupled to the source entity. If the switch interface unit detects activity on the first unilateral path, the switch interface unit provides a collision indication to the source entity before the source entity has finished transmitting the transmit packet. Because the collision is provided before the source has finished transmitting the packet, the source entity logs a collision as it would in any LAN collision.

If, however, the switch interface unit detects no activity on the first unilateral path, the switch interface unit establishes a second unilateral path from the source entity to the destination entity to allow communications. A first-in-first-out buffer or the like delays the transmit packet a sufficient amount of time to allow the collision determination to be made.

Thus, the entire connection operation described in the U.S. patent application Ser. No. 09/203,016 is provided within the standard communication requirements of a physical layer switching operation. As a result, connectivity between multiple entities on multiple LANs may be accomplished relatively quickly.

Within a LAN section, all terminals are typically communicatively connected to each other through a hub, which repeats its received packets to all the terminals within that LAN section. Therefore, all terminals within a LAN section use the same transmission speed to communicate with each other. However, the terminals in multiple LAN sections may use different transmission speeds. Connecting multiple LAN sections having different transmission speeds does not cause problem at packet layer because the packet layer protocol allows holding the packets received from source devices or terminals and transmits the received packets when connectivity to a destination entities is available. However, connecting multiple LAN sections having different transmission rates imposes difficulties within physical layer protocol because substantial delay is not allowed at physical layer. In addition, the methodology for interconnecting multiple LANs (or other network sections) described in U.S. patent application Ser. No. 09/203,016 does not address the issue of interconnecting network sections that operate at different transmission speeds or data rates.

Consequently, there is a potential need for connecting multiple LAN sections having different transmission speeds within physical layer protocol.

### SUMMARY OF THE INVENTION

The present invention addresses the above need, as well as others, by providing a method and arrangement for communicating information between a plurality of local area network sections having different transmission speeds. To this end, a packet is received into a buffer and re-transmitted to a destination hub at a different speed. Delay is introduced to allow a determination to be made as to whether the destination hub is idle. However, such determination is made prior to receipt of the entire source packet in order to achieve connectivity at the physical layer.

One exemplary embodiment of the present invention is a method for communicating information between a plurality of local area network sections having different transmission speeds, the plurality of local area network sections employing a physical layer protocol in which an unsuccessful transmission is communicated to a transmission source prior to completion of the transmission. One step includes receiving, within the physical layer protocol, a packet that is transmitted from a source terminal in a source network section having a source transmission speed to a destination terminal in a destination network section having a destination transmission speed, the destination transmission speed differing from the source transmission speed. Another step involves determining the transmission speed for the destination terminal. The method further includes the step of re-transmitting, within the physical layer protocol, the received packet to the destination network section at the destination transmission speed.

Another embodiment of the invention includes an arrangement for switching between a plurality of hubs that employ a plurality of data rates. The arrangement includes a cross point switch and data speed converter. The cross point switch has a plurality of ports, each port operably coupled to one of the plurality of hubs, the cross point switch operable to couple a first port to a second port. The data speed converter is operable to receive packet data transmitted from a first hub at a first data rate, and is further operable to re-transmit the packet data to the first port at a second data rate, the second data rate employed by a second hub connected to the second port.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows an exemplary Ethernet switching system, in accordance with the present invention;

FIG. 2 shows the space division switch illustrated in FIG. 1 in further detail, in accordance with the present invention;

FIG. 3 shows a diagram of the structure of Ethernet packet;

FIG. 4 shows a diagram of the structure of a jam packet;

FIG. 5 shows a source to destination switch matrix and a destination to source switch matrix which are used to illustrate the principle to implement the connectivity between three port inputs and three port outputs, in accordance with the present invention;

FIG. 6 shows the cross-point switch 201 illustrated in FIG. 2 in further detail, in accordance with the present invention;

FIG. 7 shows further details of the control circuits as illustrated in FIG. 7, in accordance with the present invention;

FIG. 8 shows further details in the data speed converter illustrated in FIGS. 2 and 6, in accordance with the present invention;

FIG. 9 are timing diagrams of packet receipt and re-transmission within the physical layer protocol in accordance with the present invention;

FIG. 10 shows a source to destination switch matrix and a destination to source switch matrix which are able to perform the connectivity between nine port inputs and nine port outputs, in accordance with the present invention;

### DETAILED DESCRIPTION

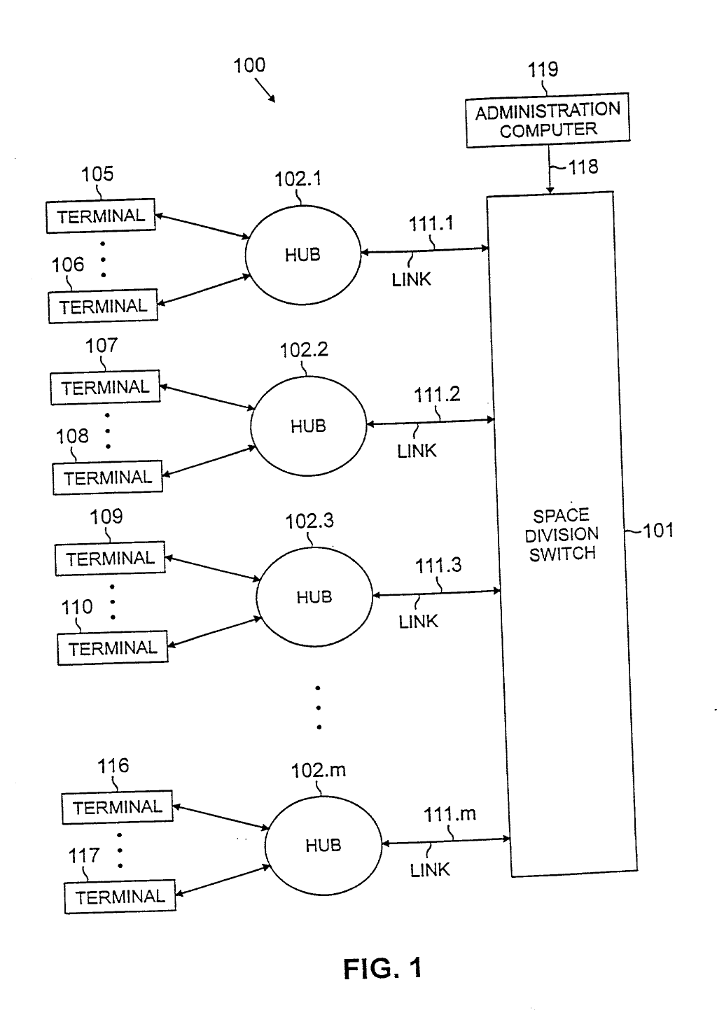

Referring to FIG. 1, there is shown an exemplary Ethernet switching system 100, in accordance with the present invention. The Ethernet switching system 100 includes a space division switch 101, a plurality of Hubs 102.1, 102.2, 102.3, . . . , and 102.n, a plurality of terminals 105-110, 116 and 117, and an administration computer 119. Each of the Hubs 102.1, 102.2, 102.3, . . . , or 102.n is coupled to the space division switch 101 via a respective link 111.1, 111.2, 111.3, . . . , or 111.n. Each of the terminals is coupled to one of the Hubs. Each Hub 102.x may operate at one of a plurality of data transmission rates or speeds. Typical rates include 1 Mb/sec, 10 Mb/sec, and 100 Mb/sec.

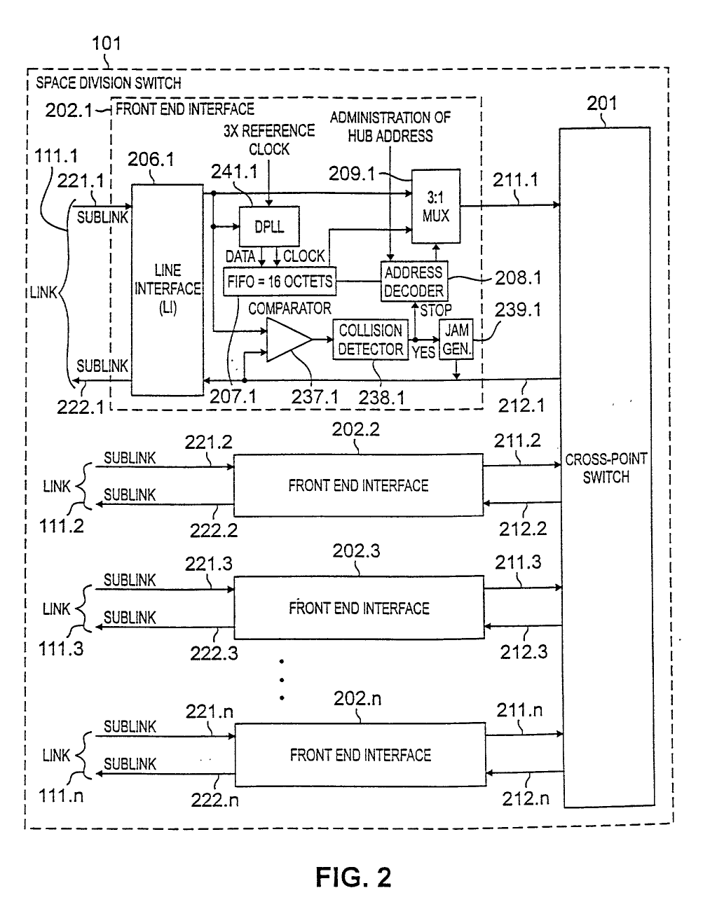

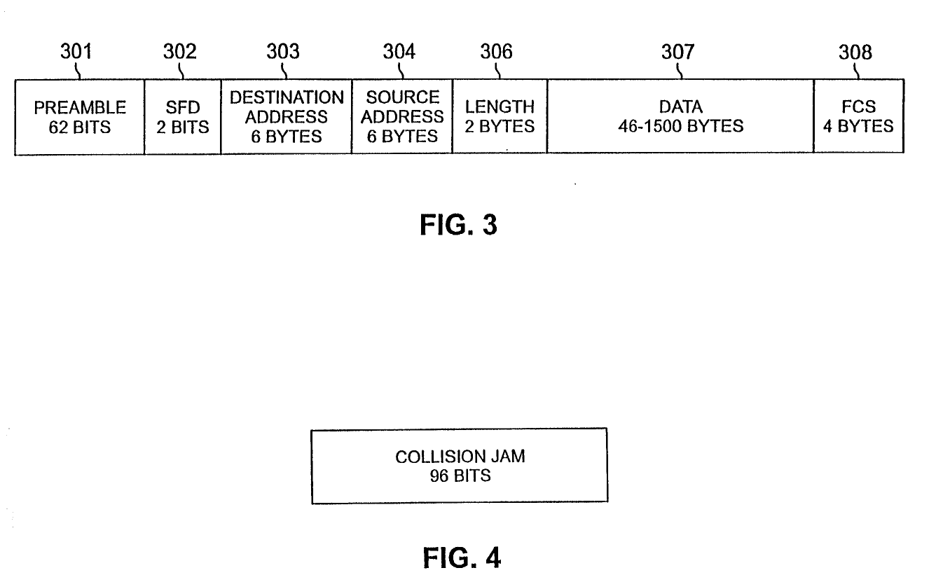

Each of the Hubs 102.1, 102.2, 102.3, . . . , or 102.n and its associated terminals constitutes a distinct network function that is capable of functioning as a stand alone unit. For example, if the terminal 105 wishes to transmit a packet as illustrated in FIG. 3 to the terminal 106, this communication is done solely within the Hub 102.1. Each of the links 111.1, 111.2, 111.3, . . . , or 111.n comprises a transmit sublink and receive sublink as will be illustrated in greater detail in FIG. 2.

The administration computer 119 maintains address information pertaining to the various hubs 102.1, 102.2, . . . , 102.n. The administration computer 119 further maintains hub speed control information that associates each connected hub with its operating hub speed. For example, the Hub 102.1 may operate at 1 Mb/s while the Hub 102.3 operates at 10 Mb/s. The administration computer 119 maintains a table or other data structure that identifies the appropriate hub speed for each attached hub. Detail regarding the use of the hub speed information is provided further below.

In the example in which the terminal 105 transmits a packet to the terminal 106, if a collision occurs in the transmission process, then a jam signal as illustrated in FIG. 4 is transmitted to ensure that all terminals coupled to the Hub 102.1 recognize that a collision has occurred. For example, if the terminal 105 was attempting to transmit a packet to the terminal 106 and another terminal was transmitting a packet at the same time on the Hub 102.1, then the terminal 105 detects a violation of the packet protocol (illustrated in FIG. 3). Upon detecting the violation (or collision), the terminal 105 generates a jam signal as illustrated in FIG. 4 and attempts to transmit the packet at a later point in time to the terminal 106. During the transmission of a packet from the terminal 105 to the terminal 106, no connection is made from the Hub 102.1 to any other Hubs through the space division switch 101.

If the terminal 105 wishes to transmit a packet to the terminal 109, which is coupled to the Hub 102.3, the terminal 105 transmits the packet to the Hub 102.1. In general, the space division switch 101 monitors the link 111.1 for destination addresses in packets that do not correspond to a terminal coupled to the Hub 102.1. When the space division switch 101 recognizes the destination address as designating the terminal 109, the space division switch 101 monitors for the activity on its corresponding Hub 102.3.

In particular, the space division switch 101, upon recognizing the destination address as being that of the terminal 109, establishes a unilateral path from the Hub 102.3 to the Hub 102.1 via the link 111.3 and the link 111.1. If no packet is presently being transmitted on the Hub 102.3, then the space division switch establishes the unilateral connection from the Hub 102.1 to the Hub 102.3 to facilitate transmission of the packet received at the Hub 102.1 from the terminal 105 to the terminal 109.

If, however, a packet is presently being transmitted on the Hub 102.3, then the space division switch 101 does not allow the transmission of the packet from the terminal 105 to the terminal 109. In such a case, the space division switch 101 signals collision to the terminal 105.

In particular, because another terminal is transmitting a packet on the Hub 102.3 and this packet is also being transmitted via the unilateral path, the space division switch 101 provides a collision signal to the terminal 105 via the Hub 102.1. The transmission of the packet on the Hub 102.3 is not interfered with since no transmission path was setup from the Hub 102.1 to the Hub 102.3.

The collision is signaled before the transmission of the packet from the terminal 105 to the space division switch 101 is complete, in accordance with the physical layer protocol.

To further the previous example, assume that the terminals 105 and 107 simultaneously attempt to transmit a packet to the terminal 109. The space division switch 101 establishes a first unilateral path from the Hub 102.3 to the Hub 102.1 and a second unilateral path from the Hub 102.3 to the Hub 102.2. If it is also assumed that the terminal 110 is transmitting a packet on the Hub 102.3, then the space division switch 101 does not allow the Hubs 102.1 and 102.2 to transmit the packets from their respective transmitting terminals to the Hub 102.3. The terminals 105 and 107 will both detect collision signals generated by the space division switch 101 and attempt to transmit at a later point in time.

Assume, however, that the terminal 110 was not transmitting a packet, and the Hub 102.3 was idle when the terminals 105 and 107 both simultaneously started to transmit a packet to the terminal 109. Both packets are allowed to be transmitted via the space division switch 101 to the terminal 109 through the Hub 102.3. However, the space division switch 101 detects a collision and generate a jam signal as illustrated in FIG. 4.

The space division switch 101 is non-blocking. This allows two terminals, each being coupled to a different Hub, to be simultaneously transmitting via the space division switch 101 to two destination terminals each being coupled to other Hubs. For example, the terminal 105 can be transmitting to the terminal 110 simultaneously with the transmission of the terminal 108 to the terminal 116. In addition, a terminal can transmit to all other terminals utilizing the broadcast capabilities of the space division switch 101.

In accordance with the present invention, the space division switch 101 is further capable of converting from the transmission speed of the source hub to the transmission speed of the destination hub. To this end, the space division switch 101 contains at least one data speed converter as discussed further below.

Referring to FIG. 2, there is shown the space division switch 101 illustrated in FIG. 1 in further detail, in accordance with the present invention. The space division switch 101 comprises a cross-point switch 201 and n front end interfaces 202.1, 202.2, 202.3, . . . , and 202.n that are coupled to the cross-point switch 201. Each of the links 111.1, 111.2, . . . , or 111.n comprises a pair of sublinks, one being a transmit sublink 221.1, 221.2, . . . , or 221.n and other being a receive sublink 222.1, 222.2, . . . , or 222.n. Each of the sublink pairs is coupled to a respective front end interface 202.1, 202.2, . . . , or 202.n. For each Hub x, the transmit sublink 221.x is utilized to transmit data from a Hub 102.x to the space division switch 101, and the receive sublink 222.x is utilized to receive data from the space division switch 101 and provide it to a Hub 102.x. The cross-point switch 201 receives n inputs (i.e. n port inputs) and switches the n inputs to n outputs (i.e. n port outputs). The n port inputs to the cross-point switch 201 are links 211.1, 211.2, . . . , and 211.n. The n port outputs from the cross-point switch 201 are links 212.1, 212.2, . . . , and 212.n.

FIG. 2 shows the front end interface 202.1 in detail, which includes a line interface (LI) 206.1, a digital phase lock loop (DPLL) 241.1, a data speed converter 207.1 (which includes a first-in-first-out buffer), an address decoder 208.1, a multiplexer (mux) 209.1, a comparator 237.1, a collision detector 238.1, and a jam generator 239.1.

All packets transmitted on the Hub 102.1 are communicated to the line interface (LI) 206.1 via the sublink 221.1. The information received by the line interface (LI) 206.1 is transmitted to the mux 209.1 and digital phase lock loop (DPLL) 241.1. The DPLL 241.1 recovers the clock and data from the information received from the line interface (LI) 206.1 and transmits the clock and data to the first in first out buffer (FIFO) of the data speed converter 207.1.

As will be discussed further below, the mux 209.1 has three modes of operation corresponding to its three inputs. In one mode of operation, the default mode, the mux 209.1 selects the input being directly received from the line interface 206.1. This mode allows other front end interfaces 202.x to monitor traffic on the hub 102.1 as necessary to determine whether the hub 102.1 is idle. In a second mode of operation, the mux 209.1 selects the input from the address decoder 208.1 to transmit address and control information to the cross point switch 201 for use by the control circuits located therein. In the third mode of operation, the mux 209.1 selects the input from the FIFO of the data speed converter 207.1 to transmit a packet from the hub 102.1 to a destination hub via the cross point switch 201. In such a case, the data speed converter 207.1 transmits the packet to the cross point switch 201 using the data speed used by the destination hub.

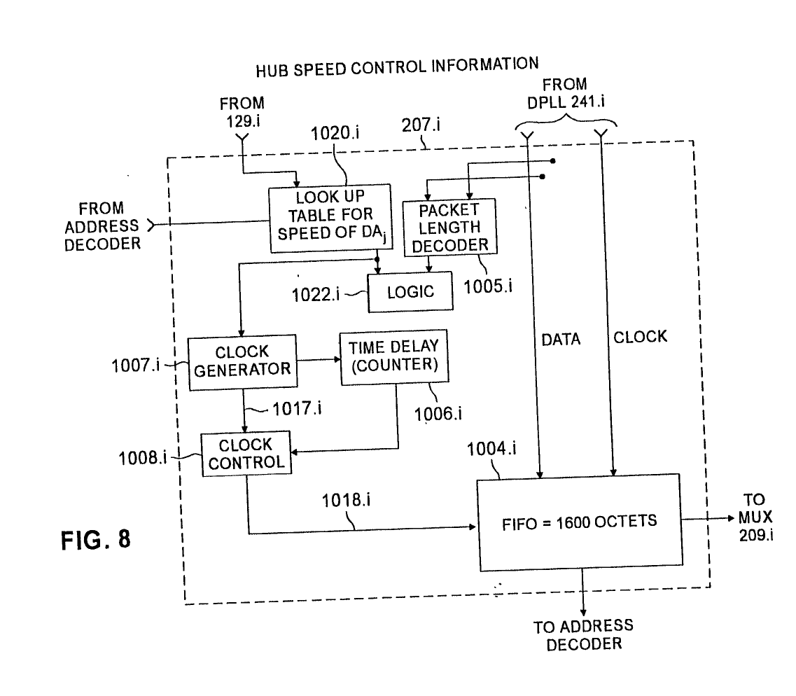

In general, in the first mode of operation the mux 209.1 remains in its default mode receives input from the line interface (LI) 206.1. In the default state, the data speed converter 207.1 also receives the data from the line interface 206.1 so that the data can be monitored for incoming packets. The FIFO within the data speed converter 207.1 has a capacity of several bytes to enable the delays needed to facilitate proper transmission between hubs of different speeds. Further detail regarding the structure and operation of an exemplary data speed converter 207.1 as used herein is provided below in connection with FIG. 8.

The address decoder 208.1 monitors the destination address of every packet as it is buffered in the data speed converter 207.1 to determine whether the packet is destined for another Hub other than the Hub 102.1. To this end, the address decoder 208.1 receives address information via the link 118.1 from the administration computer 119. The address decoder 208.1 stores the address information in a table so that it may be used when needed.

Consider the example in which the terminal 105 is attempting to transmit a packet to the terminal 109. In the following description, it is assumed that the hub 102.1 operates at 1 Mb/sec and the Hub 102.3 operates at 10 Mb/sec. When the address decoder 208.1 determines that the destination address field from an incoming packet designates that the packet is going to the terminal 109 via the Hub 102.3, the address decoder 208.1 signals the collision detector 238.1.

The address decoder 208.1 then transmits an address and control information via the mux 209.1 and the link 211.1 (or port (1) input) to the cross point switch 201 to establish a unilateral (reverse) path from the Hub 102.3. To this end, the mux 209.1 operates in its second mode. The mux 209.1 in its second mode transmits the address and control information in a manner that is distinguishable from ordinary Ethernet data. In the example, described herein, the mux 209.1 transmits address and control information to the cross point switch 201 using a higher voltage bias level. As a result, the control circuitry within the cross point switch 201 can distinguish local address and control information (upon which it may act) from Ethernet data to be transmitted (which it should ignore).

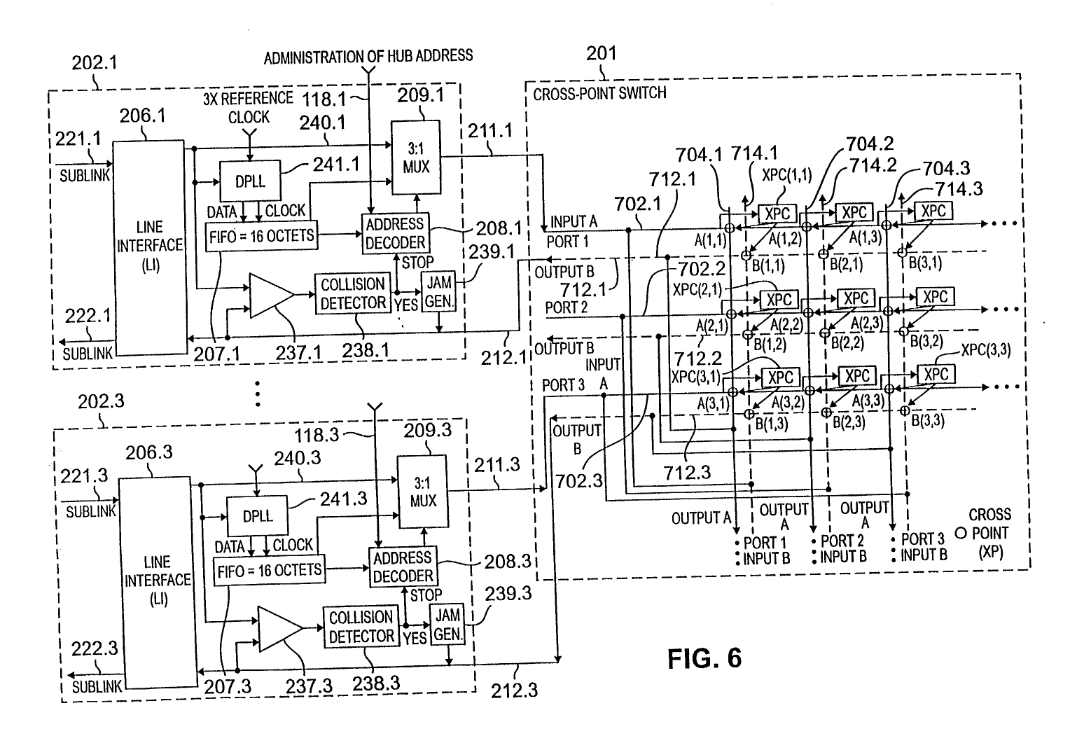

In any event, the cross point switch 201 establishes the reverse unilateral path. The unilateral path includes the sublink 221.3, front end interface 202.3, link 211.3, cross point switch 201 and link 212.1. The collision detector 238.1, using the comparator 237.1, monitors this unilateral path to determine whether the Hub 102.3 is idle. Details regarding the operations of the cross point switch 201 that establish the unilateral path from the Hub 102.3 are provided below in connection with FIGS. 6, 7 and 8.

If the Hub 102.3 is idle, then the collision detector 238.1 enables the mux 209.1 so that the output of the data speed converter 207.1 can be transmitted via the link 211.1, cross-point switch 201, link 212.3, and link 222.3 to the Hub 102.3. To this end, upon detecting that there is no activity in the Hub 102.3, the address decoder 208.1 establishes via the mux 209.1 a unilateral (forward) path via the cross-point switch 201 to allow the transmission of data from the link 211.1 to the link 212.3. To transmit the packet, the mux 209.1 reduces its output voltage level and transmits the packet data from the data speed converter 207.1 over the link 211.1. The data speed converter 207.1 transmits data at the transmission speed of the destination Hub 102.3, which is 10 Mb/sec. The data speed converter 207.1, however, delays the transmission to ensure that it does not try to complete re-transmission prior to receipt of all of the incoming packet, which is received at the much slower rate of 1 Mb/sec. Details regarding the operations of the cross point switch 201 that establish the unilateral path to the Hub 102.3 are provided below in connection with FIGS. 6, 7 and 8.

If, however, the Hub 102.3 is not idle when the terminal 105 attempts to transmit a packet to it, the collision detector 238.1 detects the non-idle condition and does not establish the path from the link 211.1 to the link 212.3 via the cross-point switch 201. The collision detector 238.1 also activates the jam generator 239.1 so that the terminal 105 can detect a collision. Then, the collision detector 238.1, using the address decoder 208.1, causes the cross point switch 201 to drop the link 211.3 to the link 212.1 connection. (See FIGS. 6, 7 and 8).

During the transmission of a packet from the terminal 105 to the terminal 109, the terminal 110 may also commence transmitting a packet. In this situation, the terminals 105 and 110 detect a collision and transmit the jam signal as illustrated in FIG. 4 to the Hub 102.3. The terminals 105 and 110 recognize the collision and will attempt transmission of the packet at a later point in time.

The Hubs 102.2, . . . , and 102.n are coupled to the cross-point switch 201 through the front end interfaces 202.2, . . . , and 202.n, respectively. The structure and function of the front end interfaces 202.2, . . . , or 202.n are the same as that of the front end interface 202.1.

Referring to FIG. 3, there is shown an Ethernet packet 300, which includes a preamble field 301, an start frame delimiter (“SFD”) field 302, a destination address field 303, a source address field 304, a length field 306, a data field 307 and an frame check sum (“FCS”) field 308. Referring to FIG. 4, there is shown a collision jam signal (or jam packet) having a unique bit pattern (e.g. 10101 . . . ) for indicating collision conditions during Ethernet packet transmissions.

Before explaining the present invention in further detail, it is helpful to summarize the process of transmitting a packet from a source port (i) to Hub (j) through a destination port (j) utilizing the space division switch 101 illustrated in FIGS. 1 and 2. The transmission process includes the following steps:

(1) establishing a first unilateral path from the destination port (j) to the source port (i);

(2) detecting, at the source port (i) via the first unilateral path, whether Hub (j) is idle;

(3) suspending the transmission and disconnecting the first unilateral path, if Hub (j) is not idle;

(4) establishing a second unilateral path from the source port (i) to the destination port (j), if Hub (j) is idle;

(5) transmitting the packet from the source port (i) first to the destination port (j), then to Hub (j), via the second unilateral path using the transmission speed of the Hub (j); and

(6) disconnecting both the first and second unilateral paths when the transmission operation is completed.

It will be appreciated from the above summary that the operation of transmitting a packet from a source port (i) to a destination port (j) involves a pair of cross points: a cross point (i, j) which is utilized to establish a unilateral path from the source port (i) to the destination port (j), and a complementary cross point (j, i) which is utilized to establish a unilateral path from the destination port (j) to the source port (i). Accordingly, the present invention uses two cross-point switch matrixes for establishing these two unilateral paths, respectively. Moreover, in the exemplary embodiment described herein, a single control circuit controls each cross point (i, j) and its complementary cross point (j, i).

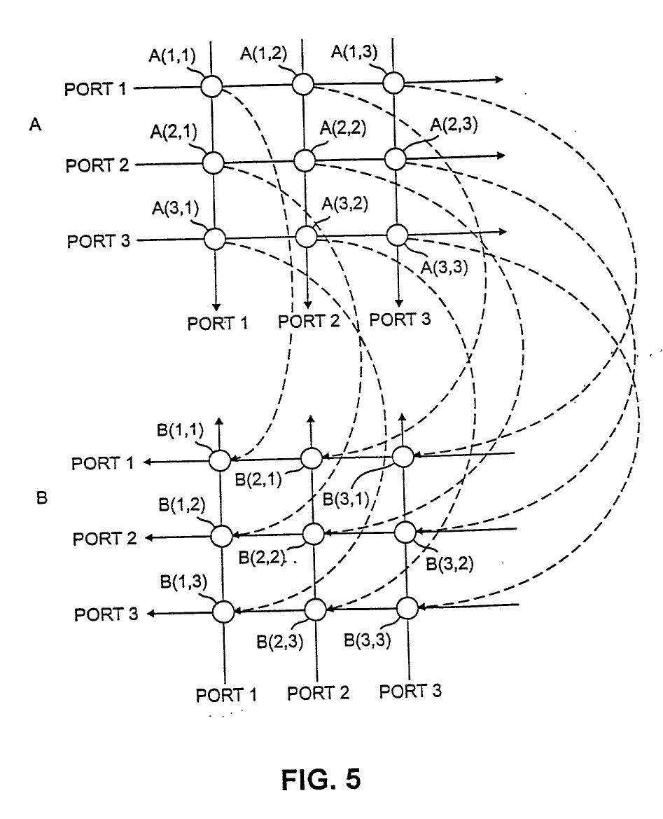

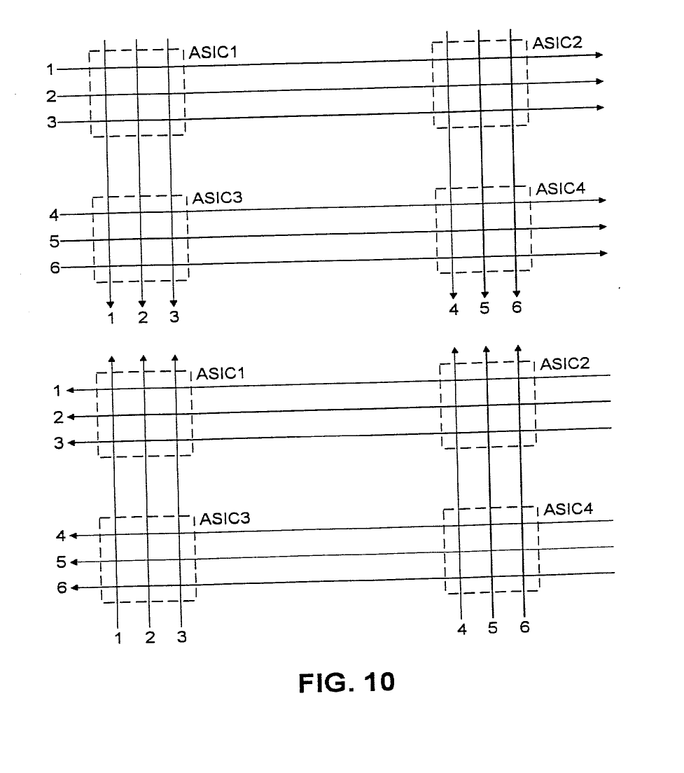

Referring to FIG. 5, there are shown two switch matrixes A and B which are used to illustrate the principle to implement the connectivity between three port transmit lines 211.1, 211.2 and 211.3 and three port receive lines 212.1, 212.2 and 212.3, in accordance with the present invention. It will be noted that actual matrices A and B would be configured to implement connectivity between substantially more than three ports, even within a single integrated circuit. However, FIGS. 5 and 6 show exemplary matrices providing connectivity between three ports to clarify explanation of the principles of the invention. Those of ordinary skill in the art may readily implement the invention to a single integrated circuit providing connectivity between up to 128 ports, or a matrix of integrated circuits providing connectivity between several hundred ports as discussed below in connection with FIG. 10.

In FIG. 5, the matrix A is the source to destination matrix, while matrix B is the destination to source matrix. Each port transmit line 211.i forms a row in the matrix A and also forms a column in the matrix B. Each port receive line 212.j forms a column in the matrix A and a row in the matrix B. The nine cross points in matrix A are denoted as:

$$\begin{matrix}A ( 1 , 1 ) , A ( 1 , 2 ) , A ( 1 , 3 ) \\ A ( 2 , 1 ) , A ( 2 , 2 ) , A ( 2 , 3 ) \\ A ( 3 , 1 ) , A ( 3 , 2 ) , A ( 3 , 3 )\end{matrix}$$

Each cross point A(i, j) (i, or j=1, 2, 3, . . . , n) is able to establish a unilateral path from a source port (i) to a destination port (j).

The nine cross points in matrix B are denoted as:

$$\begin{matrix}B ( 1 , 1 ) , B ( 2 , 1 ) , B ( 3 , 1 ) \\ B ( 1 , 2 ) , B ( 2 , 2 ) , B ( 3 , 2 ) \\ B ( 1 , 3 ) , B ( 2 , 3 ) , B ( 3 , 3 )\end{matrix}$$

Each cross point B(j, i) (j, or i=1, 2, 3, . . . , n) is able to establish a unilateral path from a destination port (j) to a source port (i).

Each cross point A(i, j) in the matrix A is paired with a corresponding complementary cross point B(j, i) in the matrix B as illustrated by the dot line between these two cross points (i, or j=1, 2, 3, . . . , n).

When a packet needs to be transmitted from a source port (i) to Hub (j) which is coupled to a destination port (j), the cross point B(j, i) in the matrix B is activated to establish a first unilateral path from the destination port (j) to the source port (i), so that the activity of Hub (j) can be monitored via the first unilateral path at the source port (i). If Hub (j) is idle, the cross point A(i, j) in the matrix A is then activated to establish a second unilateral path from the source port (i) to the destination port (j), so that a packet can be transmitted from the source port (i) to Hub (j) via the second unilateral path. After the transmission of the packet is completed, the cross points A(i, j) and B(j, i) are deactivated to release the first and second unilateral paths.

Referring to FIG. 6, there is shown the cross-point switch 201 illustrated in FIG. 2 in further detail, using the principle illustrated in FIG. 5, in accordance with the present invention. The cross-point switch 210 includes two switch cross point matrices (A and B). The matrix A delineated by solid lines is the source to destination matrix, and the matrix delineated by the dotted lines is the destination to source matrix. Each of the two matrixes has n rows and n columns of cross points. However, to facilitate description of the present invention, FIG. 6 specifically shows three rows and three columns for each matrix.

The matrix A includes three row connections 702.1, 702.2, 702.3 and three column connections 704.1, 704.2, 704.3. The three row connections 702.1, 702.2, 702.3 are coupled, respectively, to the port transmit lines 211.1, 211.2 and 211.3. The three column connections 704.1, 704.2, 704.3 are coupled, respectively, to the port receive lines 212.1, 212.2, 212.3.

In other words, the transmit line 211.i of port (i) in the matrix A is coupled to the row connection 702.i, and the receive line 212.i of port (i) in the matrix A is coupled to the column connection 704.i (i=1, 2, 3, . . . , n). The cross connections between the three row connections and three column connections forms a matrix of 3×3 cross points, which is denoted as:

$$\begin{matrix}A ( 1 , 1 ) , A ( 1 , 2 ) , A ( 1 , 3 ) \\ A ( 2 , 1 ) , A ( 2 , 2 ) , A ( 2 , 3 ) \\ A ( 3 , 1 ) , A ( 3 , 2 ) , A ( 3 , 3 )\end{matrix}$$

Each cross point A(i, j) in the matrix A is able to establish a unilateral path from a source port (i) to a destination port (j) (i, or j=1, 2, 3, . . . , n).

The matrix B includes three row connections 712.1, 712.2, 712.3 and three column connections 714.1, 714.2, 714.3. The three row connections 712.1, 712.2, 712.3 are coupled, respectively, to the port receive lines 212.1, 212.2 and 212.3. The three column connections 714.1, 714.2, 714.3 are coupled, respectively, to the port transmit lines 211.1, 211.2, 211.3.

In other words, the receive line 212.i of port (i) in the matrix B is coupled to the row connection 712.i, and the transmit line 211.i of port (i) in the matrix B is coupled to the column connection 714.i (i=1, 2, 3, . . . , n). The cross connections between the three row connections and three column connections forms a matrix of 3×3 cross points, which is denoted as:

$$\begin{matrix}B ( 1 , 1 ) , B ( 2 , 1 ) , B ( 3 , 1 ) \\ B ( 1 , 2 ) , B ( 2 , 2 ) , B ( 3 , 2 ) \\ B ( 1 , 3 ) , B ( 2 , 3 ) , B ( 3 , 3 )\end{matrix}$$

Each cross point B(j, i) in the matrix B is able to establish a unilateral path from a destination port (j) to a source port (i) (j, or i=1, 2, 3, . . . , n).

It will be appreciated from the above discussion that each port transmit line 211.i is coupled to a row connection 702.i of matrix A and a column connection 714.i of matrix B. Likewise, each port receive line 212.i is coupled to a row connection 712.i of matrix A and a column connection 704.i of matrix B.

The cross-point switch 201 further includes a matrix of (3×3) cross point control circuits (XPCs) that are denoted as:

$$\begin{matrix}XPC ( 1 , 1 ) , XPC ( 1 , 2 ) , XPC ( 1 , 3 ) \\ XPC ( 2 , 1 ) , XPC ( 2 , 2 ) , XPC ( 2 , 3 ) \\ XPC ( 3 , 1 ) , XPC ( 3 , 2 ) , XPC ( 3 , 3 )\end{matrix}$$

Each XPC(i, j) is coupled A(i, j) and B(j, i) so that the XPC(i, j) can individually control (activate or deactivate) both the cross point A(i, j) in the matrix A and its complementary cross point B(j, i) in the matrix B. Moreover, each XPC(i, j) in the ith row is coupled to receive control/address signals from each port (i) through the port transmit line 211.i and the row connection 702.i. Thus, for example, the XPC(1, 1), the XPC(1, 2), and the XPC(1, 3) are all coupled to receive information via the port transmit line 211.1.

As illustrated in FIG. 2, each of n front end interfaces 202 is coupled to the cross-point switch 201. FIG. 6 shows the connection details between the front end interfaces 202.1 and 202.3 and the cross-point switch 201. Specifically, in the front end interface 202.1, the port transmit line or link 211.1 is coupled to the line interface 206.1 via the mux 209.1. The port receive line or link 212.1 is coupled to, among other things, the line interface (LI) 206.1. In the front end interface 202.3, the port transmit line 211.3 is coupled to the line interface 206.3 via the mux 209.3 and the port receive line 212.3 is also coupled to the line interface (LI) 206.3.

By the same token, all other front end interfaces are coupled to the cross-point switch 201 in the same way as that of the front end interface 202.1 or 202.3. Specifically, the port transmit line 211.i is coupled to the line interface 206.i via the mux 209.i and the port receive line 212.i is coupled to the line interface (LI) 206.i.

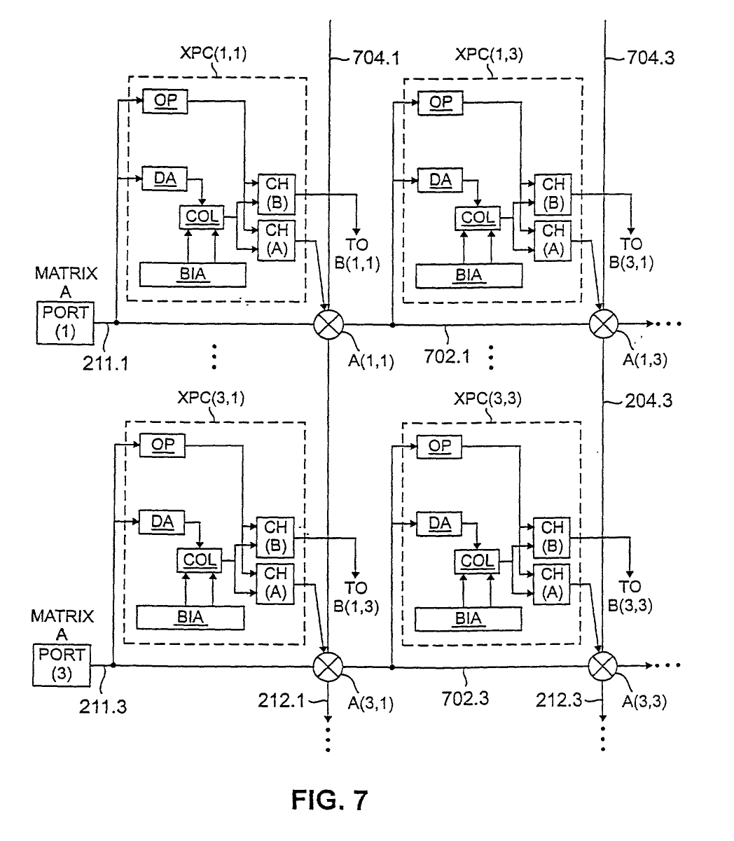

Referring to FIG. 7, there are shown further details of the control circuits XPCs illustrated in FIG. 6, in accordance with the present invention. Specifically, FIG. 7 shows the first and third row connections 702.1 and 702.3 and first and third column connections 704.1 and 704.3 in the matrix A. There are shown two control circuits in the first row connections XPC(1, 1) and XPC(1, 3); and two control circuits in the third row XPC(3, 1) and XPC(3, 3). The matrix A includes four cross points A(1, 1), A(1, 3), A(3, 1) and A(3, 3). Each of four control circuits XPC(1, 1), XPC(1, 3), XPC(3, 1) and XPC(3, 3) is coupled to and controls a respective cross point A(1, 1), A(1, 3), A(3, 1) or A(3, 3) and the matrix A. Each of four control circuits XPC(1, 1), XPC(1, 3), XPC(3, 1) or XPC (3, 3) also is coupled to, and controls a respective cross point B(1, 1), B (3, 1), B (1, 3) and B(3, 3) in the matrix B, which are not shown in FIG. 7.

In each of the control circuits illustrated in FIG. 7, the DA block is a register for storing the local destination address which is received during operation via the port transmit line 211.i and the row connection 702.i. The built-in address block BIA is non-volatile memory for storing the built-in destination address for that control circuit. For example, for XPC(i, j), its built-in address is DAj. The OP block is the register for storing the CONNECT_A, CONNECT_B or DISCONNECT operation request, also received via the port transmit line 211.i and the row connection 702.i. The COL block is configured to compare the destination address in the DA register with the built-in address stored in block BIA. When the destination address in the DA register matches the built-in address in block BIA, the COL block generates a control signal to the CH(A) and CH(B) blocks. Under the control of the OP block and COL block, each of the CH(A) and CH(B) blocks controls (activate or deactivate) a corresponding cross point in the matrix A and a corresponding complementary cross point in the matrix B, respectively.

One feature of the present invention is the ability to switch between network sections (hubs and terminals) that operate at different transmission speeds within the physical layer protocol. In other words, not only can the method of the present invention switch between terminals connected to different hubs within the physical layer protocol (i.e. detecting a collision on a destination hub prior to completion of the transmission of the packet by the source terminal), but also to switch between terminals connected to different hubs that use different transmission speeds. The ability to switch between network sections using different transmission speeds greatly enhances the flexibility of the network elements that may be connected at the physical layer.

Referring to FIG. 8, there is shown further details in the data speed converter 207.i (i=1, 2, . . . , n) illustrated in FIGS. 2 and 6, in accordance with the present invention. The data speed converter 207.i assists in coordinating the conversion between different data transmission speeds.

The data speed converter 207.i includes a FIFO 1004.i, a packet length decoder 1005.i, a time delay (counter) 1006.i, a clock generator 1007.i, a clock control 1008.i, a look-up table 1020.i, and a logic block 1022.i. It will be appreciated that the configuration of the data speed converter 207.i shown in FIG. 8 is given by way of example only. Those of ordinary skill in the art readily employ different configurations of a data speed converter 207.i according to the present invention.

The FIFO 1004.i is connected to receive incoming packet data and clock information from the DPPL 241.i. The FIFO 1004.i is further connected to transmit the received packet data to the mux 209.i in conjunction with the receipt of clock signals provide by the clock control 1008.i. The FIFO 1004.i preferably can store 1600 octets (or bytes) to ensure that an entire packet (or nearly an entire packet) may be stored prior to retransmission. Such storage is necessary when converting from a slower source to a faster destination. The FIFO 1004.i is further connected to the address decoder 208.i to allow the address decoder 208.i access to the destination address information upon receipt of those fields of the incoming packet.

The packet length decoder 1005.i is a logic device or decoder that is operable to decode the length field 306 (as illustrated in FIG. 3) received from the DPLL 241.i and routes the decoded packet length to the logic block 1022.i.

The time delay counter 1006.i is a counter that includes a count input connected to the logic block 1022.i. The time delay counter 1006.i is operable to count down from the number provided by the logic block 1022.i, performing a count for every clock pulse, until zero is reached. Upon reaching zero, the time delay counter 1006.i is operable to provide a signal to the clock control 1008.i. The clock input of the time delay counter is operably coupled to receive clock signals from the clock generator 1007.i.

The clock generator 1007.i is a device that is operable to generate clock pulses at a select one of a plurality of rates. The clock generator 1007.i is operably coupled to obtain input from the look-up table 1020.i representative of a desired clock rate. The clock generator 1007.i provides an output clock that is consistent with the output of the look-up table 1020.i.

The clock control 1008.i is operably coupled to receive the clock signal from the clock generator 1007.i, receive a control signal from the time delay counter 1006.i, and provide as output the clock signal only when the control signal is present. To this end, the clock control 1008.i may suitably be an and-gate with its respective inputs coupled o the clock generator 1007.i and the time delay counter 1008.i. The output of the clock control 1008.i is operably coupled to the FIFO 1004.i to clock out the output of the FIFO 1004.i to the mux 209.i.

The look-up table 1020.i is operably connected to receive speed information pertaining to the various possible destination hubs (or destination network sections) from the administration computer 119. The look-up table 1020.i receives such information from time to time and stores it as a table. The look-up table 1020.i is also operable coupled to receive destination address information from the address decoder 208.i. The look-up table 1020.i is operable to generate an output that is representative of the destination speed based on the received destination address information.

The logic circuit 1022.i is operably connected to receive the destination speed information from the look-up table 1020.i and the packet length from the packet length decoder 1005.i. The logic circuit 1022.i is operable to determine an appropriate amount of delay from the packet length, destination speed and source speed. The source speed is constant for the data speed converter 207.i because it is the speed of the Hub(i) to which it is connected. As a result, the logic circuit 1022.i may either obtain the source speed information from some other circuit or the source speed may be inherent within the operation of the logic circuit 1022.i.

The logic circuit 1022.i has basically three operating cases. In the first case, the source speed is the same as the destination speed. In such a case, the logic circuit 1022.i provides as an output a count number representative of an appropriate delay. The appropriate delay is one that is necessary to allow the address decoder 208.i to check the destination Hub(j) for activity and set up the transmission path to the destination Hub(j) if Hub(j) is determined to be idle. The count number is a representative of the appropriate delay in terms of the destination clock speed. In the first case, the count number will typically be a constant, predetermined value.

In the second case, the source speed is greater than the destination speed. In such a case, the logic circuit 1022.i provides a different count number. As before, the count number is representative of the delay that is necessary to allow the address decoder 208.i to check the destination Hub(j) and connect to it if it is determined to be idle. However, because the destination clock speed is slower than the source speed, the count number will typically be smaller than that used for the first case. In other words, while the delay time may be the same, the count number is less because it represents the delay time in terms of the slower destination clock speed.

In the third case, the source speed is less than the destination speed. In such a case, the logic circuit 1022.i provides a count number that is representative of the delay that is necessary to ensure that the FIFO 1004.i does not run out of incoming packet data before the incoming packet is completely received. For example, if incoming packet data is received at 1 Mb/sec and the destination clock speed is 10 Mb/sec, then there is a danger that the FIFO 1004.i may clock out a packet's worth of bytes before the last bytes of the incoming packet are received. As a result, garbage data within the FIFO 1004.i would be clocked out. Accordingly, to avoid such a result, the logic circuit 1022.i provides a delay that is based on the packet length and takes into consideration the destination clock speed.

FIG. 8 shows the timing diagrams of packet transmission from a source network section to a destination network section that illustrate the delays generated by the logic circuit count numbers under the first, second and third cases of operation discussed above.

Timing diagrams 902 and 904 show the timing diagrams representative of a packet transmission from a source network section to a destination network section wherein both network sections operate at the same speed. Thus, timing diagrams 902 and 904 correspond to the first case operation of the logic block 1022.i. The timing diagram 902 represents the receipt of the packet from the source Hub(i) into the FIFO 1004.i. The timing diagram 904 represents the transmission of the packet from the FIFO 1004.i to the destination Hub(j) through the crosspoint switch 201. The delay t between beginning of the receipt of the incoming packet and the beginning of the re-transmission of the packet should be sufficient to allow the address decoder 208.i to determine that the Hub(j) is idle and to set up the connection to the Hub(j). The delay t is controlled by the logic block 1022.i, as discussed above. It will be noted, however, that at least some of the delay t is attributable to the inherent delay in receiving the beginning of the incoming packet and parsing the destination address therefrom, which occurs prior to the operation of the logic block 1022.i.

Timing diagrams 906 and 908 show the timing diagrams representative of a packet transmission from a source network section to a destination network section wherein the source network section operates at a greater speed than the destination network section. Thus, timing diagrams 906 and 908 correspond to the second case operation of the logic block 1022.i. The timing diagram 906 represents the receipt of the packet from the source Hub(i) into the FIFO 1004.i. The timing diagram 908 represents the transmission of the packet from the FIFO 1004.i to the destination Hub(j) through the crosspoint switch 201. As with the first case illustrated by timing diagrams 906 and 908, the delay t between beginning of the receipt of the incoming packet and the beginning of the re-transmission of the packet should be sufficient to allow the front end interface 202.i to determine that the Hub(j) is idle and to set up the connection to the Hub(j). The delay t is controlled by the logic block 1022.i, and incorporates any inherent delay in the operation of address decoder 208.i. It will be appreciated that because the incoming packet is received at a faster rate than it is re-transmitted in the second case, the delay t should be chosen to ensure that the re-transmission at least begins before the incoming packet is completely received. Re-transmission should begin before the packet is completely received to ensure that the front end interface 202.i can signal a collision to the source terminal prior to completion of the transmission of the packet in the event that the destination Hub(j) is not idle.

In general, the delay t may be, but need not be, substantially the same for the first case and the second case. As discussed above, the count number provided by the logic block 1022.i may differ in the first and second case if the destination clock speeds differ.

Timing diagrams 910 and 912 show the timing diagrams representative of a packet transmission from a source network section to a destination network section wherein the source network section operates at a slower speed than the destination network section. Thus, timing diagrams 910 and 912 correspond to the third case operation of the logic block 1022.i. The timing diagram 910 represents the receipt of the packet from the source Hub(i) into the FIFO 1004.i. The timing diagram 912 represents the re-transmission of the packet from the FIFO 1004.i to the destination Hub(j) through the crosspoint switch 201. In contrast to the first and second cases, the delay t_{I}, between beginning of the receipt of the incoming packet and the beginning of the re-transmission of the packet is increased to allow for the receipt of more of the incoming packet. In particular, because the re-transmission rate is higher, there is a potential for the re-transmission to attempt to transmit portions of the incoming packet data before they are received. Such attempts could result in erroneous data. Accordingly, the re-transmission is delayed to ensure that the re-transmission completes on or after receipt of all of the incoming packet. As discussed above, the logic block 1022.i determines the appropriate delay (at least in terms of determining a corresponding count value) based on the incoming packet length and the difference in clock rates.

An exemplary operation of the circuits described above in FIGS. 1, 2, 6, 7, and 8 is provided below. The exemplary operation comprises the process of transmitting a packet from a Hub (i) that is coupled to a source port (i) to a Hub (j) that is coupled to a destination port (j) (i or j=1, 2, . . . , n). In describing the process, it is assumed that the source port (i) is port (1) and the destination port (j) is port (3). More particular, it is assumed that the terminal 105 is the source terminal and the terminal 109 is the destination terminal.

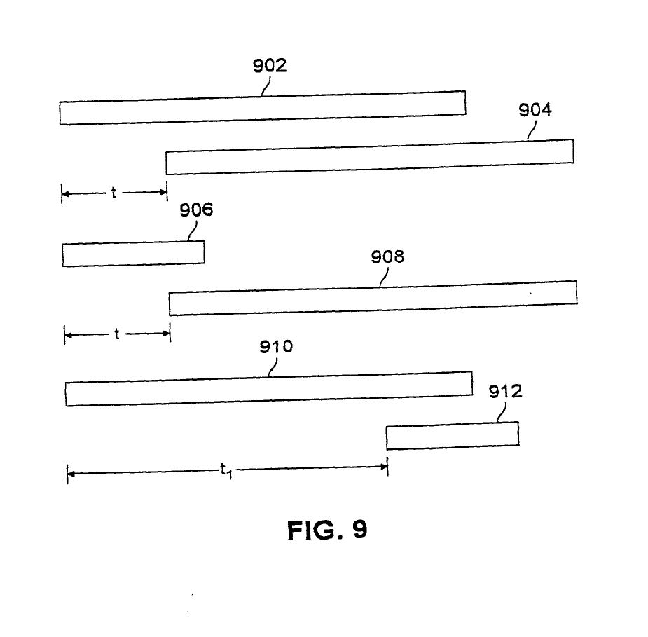

At first, the source terminal 105 sends a packet to the front end interface 202.1 via the sublink 221.1. The packet travels at the source transmission speed, i.e. the speed of the Hub (1), which is 1 Mb/sec. The packet propagates through the line interface 206.1 to the DPLL 241.1. The DPLL 241.1 recovers the clock and provides the clock and data to the FIFO 1004.1 (FIG. 9) and the packet length decoder 1005.1 (FIG. 9). As the destination address DAj information is received by the FIFO 1004.1, the address decoder 208.1 obtains the destination address DAj and determines the appropriate internal address within the cross point switch 201. At this point, the FIFO 1004.1 continues to receive additional bytes of the incoming packet.

The address decoder 208.1 monitors the destination address of the packet to determine whether the destination address is located in the source Hub (1). If the destination address is in the source Hub (1), then the cross point switch 201 is not needed and the operation ends. However, in the exemplary operation discussed herein, the destination address is connected to the Hub (3). Accordingly, the operation continues as described below.

The address decoder 208.1 transmits via the 3:1 mux 209. 1, the destination address=DAj and operation=CONNECT_B to the port transmit line 211.1. In this example, the mux 209.1 sends the destination address (DA3) over the port transmit line 211.1 to control circuits XPC(1, 1), XPC(1, 2), XPC(1, 3), . . . , XPC(1, n). Each of such control circuits in the ith row receives and stores the DAj information in its DA register and the CONNECT_B information within its OP register. Thus, in the example described herein, the control circuits XPC(1, 1), XPC(1, 2), XPC(1, 3), . . . , XPC(1, n) load their the DA registers with DA3 indicating the destination port is port (3) and loads their OP registers with CONNECT_B.

Thereafter, the COL block in each of the control circuits in the ith (first) row compares its built-in DA address in the BIA block with the destination address received in their DA registers in step 904. In other words, the COL block of each XPC(1, x) determines whether the received information includes DAj. If the built-in address does not match the received destination address, then the control circuit ignores this message. If the built in address matches the destination address, then the COL block of the control circuit XPC(i, j) generates and provides a control signal to its respective CH(A) and CH(B) blocks. Thus, in the exemplary embodiment described herein, the COL block that does not ignore the message is the COL block in XPC(1, 3). That COL block generates a control signal to its respective CH(A) and CH(B) blocks.

The CH(B) block in the matched control circuit XPC(i, j) performs the operation stored in its OP register, CONNECT_B. Accordingly, the CH(B) block of the control circuit XPC(i, j) activates the cross point B(j, i) to establish a first (reverse) unilateral path from the destination port (j) to the source port (i). In this example, the CH(B) block of the control circuit XPC(1, 3) activates the cross point B(3, 1). The first unilateral path includes the link 211.3, the cross-point switch 201 and the link 212.1. It is noted that the link 211.3 receives signals on the Hub (3) via the mux 209.3 from the direct link 240.3, which bypasses the FIFO 241.3.

Thereafter, the comparator 237.i and collision detector 238.i monitor, via the first unilateral path, whether Hub (j) is idle. Thus, the comparator 237.1 and the collision detector 238.1 monitor the first unilateral path to determine whether Hub (3) is idle.

If Hub (3) is not idle, the jam generator 239.1 generates a collision jam signal, which is then provided back to the Hub (1) and thus the source terminal 105. In accordance with one aspect of the present invention, the collision jam signal is provided to the source terminal 105 before the source terminal 105 has completed transmission of the packet. As a result, the collision jam signal is provided in accordance with the physical layer switching protocol. In particular, as discussed above, in the physical layer, the source of the packet must detect a collision before it is done transmitting the packet.

Continuing in the assumption that destination Hub (j) is not idle, the address decoder 208.i sends, via the mux 209.i, DAj and operation=DISCONNECT_B to the control circuits XPC(i, 1), XPC(i, 2), XPC(i, 3), . . . , and XPC(i, n). Only XPC(i, j) acts on this message. Specifically, the CH(B) in the control circuit XPC(i, j) deactivates the cross point B(j, i) in the matrix B to release the first unilateral path. Thus, in the exemplary operation discussed herein, the control circuit XPC(1, 3) receives the DISCONNECT_B information and deactivates the cross point B(3, 1) responsive thereto. The operation then ends.

However, assuming that the destination Hub (j) is determined to be idle, the CH(A) block in the control circuit XPC(i, j) activates the cross point A(i, j) (A(1, 3) in this exemplary operation) to establish a second unilateral path from the source port (i) to the destination port (j). To this end, the address decoder 208.i preferably sends DAj and operation=CONNECT_A to all of the XPCs connected to the port transmit line 211.i. The control circuit XPC(i, j) then performs the received operation, CONNECT_A. Thus, in this example, the control circuit XPC(1, 3) causes the cross point A(1, 3) to be activated to establish the second (forward) unilateral path that includes the link 211.1, the cross-point switch 201 and the link 212.3.

In the meantime, the data speed converter 207.1 operates as follows to control the flow of data out of the FIFO 1004.1. In general, the data speed converter 207.1 operates to delay the re-transmission of the incoming packet data by an appropriate that is based on the source network section transmission speed, the destination network section transmission speed, and in some cases, the packet length.

In particular, the look-up table 1020.1 receives the destination address information from the address decoder 208.1 and identifies the destination clock speed therefrom. The look-up table 1020.1 provides information representative of the destination clock speed to the logic block 1022.1 and the clock generator 1007.1. The logic block 1022.1 identifies which of the first, second or third case of operation (discussed above) is appropriate based on the destination clock speed and the source clock speed. The logic block 1022.1 then determines the appropriate count number (to provide the appropriate delay in re-transmission) in accordance with the identified case. The logic block 1022.1 provides the count number to the time delay counter 1006.1.

In the meantime, the clock generator 1007.1 generates a clock signal having the clock rate of the destination network section based on the information received from the look-up table 1020.1. The time delay counter 1006.1 provides no output signal, and thus the clock control 1008.1 does not propagate the clock signal to the FIFO 1004.1. As a result, the FIFO 1004.1 does not immediately re-transmit any of the incoming packet data to the mux 209.1.

The time delay counter 1006.1 then counts down from the count number using the clock generated by the clock generator 1007.1. When the time delay counter 1006.1 counts to zero, the time delay counter 1006 then provides the control signal to the clock control 1008.1 and holds it there. The clock control 1008.1 then propagates the clock signal through to the FIFO 1004.1 responsive to the control signal.

The FIFO 1004.1 responsive to the clock signal, clocks out the packet data in first in, first out format at the destination clock speed. The FIFO 1004.1 provides the data to the mux 209.1, which in turn propagates the data through the second (forward) unilateral path to the destination Hub (3). Specifically, the packet in the FIFO 207.1 propagates to the port transmit link 211.1 and then to the port receive link 212.3 via cross point A(1, 3).

During the delay and at least while the incoming packet is being received, the collision detector 238.1 continues to monitor whether the Hub (3) remains idle. If the destination Hub (3) does not remain idle, the jam generator 239.1 generates a collision jam signal and end the transmission. In general, however, no terminal connected to Hub (3) will start transmission once the Hub (3) starts receiving the packet from the Hub (1) front end interface 202.1. Accordingly, collisions typically will not occur once the FIFO 1004.1 starts clocking out the packet.

Once re-transmission of the packet from the FIFO 1004.1 is complete, the address decoder 208.1 sends to the control circuits in the ith row the following information: operation=DISCONNECT_AB and DAj. However, only the control circuit XPC(i, j) acts on this message. Specifically, the CH(B) in the control circuit XPC(i, j) deactivates the cross point B(j, i) (B(3, 1) in this example) in the matrix B to release the first unilateral path. At the same time, the CH(A) in the control circuit XPC(i, j) deactivates the cross point A(i, j) (A(1, 3) in this example) in the matrix A to release the second unilateral path. The operation then ends.

Thus, the present invention allows for switching between network sections that use different transmission rates or speeds. Thus, not only can physical layer switching occur between different network sections or hubs, but also between different network sections or hubs using different data rates.

In the exemplary embodiment described above, the control of both cross points necessary to perform a physical layer switching operation through communication to only a single control circuit. Moreover, in the preferred embodiment described above, communication of information to the cross points may be accomplished through the same port transmit link that carries the transmitted packet.

It will be appreciated that the form of the control circuits may vary. Those of ordinary skill in the art may readily devise other control circuits that receive address and control information and control complementary cross points to establish reverse and forward path communication links in the sequence described generally above. Such other control circuits may require somewhat different control signals. For example, one other control circuit may include some state machine functionality that eliminates the need for separate CONNECT_B and CONNECT_A operations. Such a circuit may only receive CONNECT information (and DAj information) and determine what operation to execute based on its current state. Likewise, other control circuits may merely require a DISCONNECT operation instead of separate DISCONNECT_B and DISCONNECT_AB.

In other alternative embodiments, the data speed converter 207.1 may readily be incorporated into other space division switch arrangements that perform inter-hub switching in the physical layer protocol. For example, those of ordinary skill in the art may readily modify the data speed converter 207.1 for use as a substitute for the FIFO circuit in the front end interface circuit of the space division switches disclosed in U.S. patent application Ser. No. 09/203,016 and U.S. patent application Ser. No. 09/747,911, both of which are incorporated herein by reference.

Referring to FIG. 10, there is shown a source to destination matrix A and a destination to source matrix B, with each of the matrixes having six rows and six columns, in accordance with the present invention. FIG. 10 illustrates that the principle described in connection with FIG. 5 can be readily extended to a multiple integrated circuits that contain a portion of each of matrices A and B to expand the switch size. Note that each integrated circuit in FIG. 10 is comprised both the source to destination matrix and the destination to source matrix.

While the invention has been illustrated and described in detail in the drawings and foregoing description, such illustration and description is to be considered as exemplary and not restrictive in character, it being understood that only the preferred embodiment has been shown and described and that all changes and modifications that come within the spirit of the invention are desired to be protected.

We claim:

1. A method for communicating information between a plurality of local area network sections having different transmission speeds, the plurality of local area network sections employing a physical layer protocol in which an unsuccessful transmission is communicated to a transmission source prior to completion of the transmission, the method comprising the steps of:
a) receiving, within the physical layer protocol, a packet that is transmitted from a source terminal in a source network section having a source transmission speed to a destination terminal in a destination network section having a destination transmission speed, the destination transmission speed differing from the source transmission speed;
b) determining the transmission speed for the destination terminal; and
c) re-transmitting, within the physical layer protocol, the received packet to the destination network section at the destination transmission speed.

2. The method of claim 1, further comprising, prior to step c, determining whether the destination network section is busy prior to the re-transmitting step.

3. The method of claim 2, further comprising, after step b, determining whether the destination network section is busy prior to the re-transmitting step.

4. The method of claim 1, wherein the step c further comprises commencing re-transmission of the received packet before the source terminal completes its transmission of the packet.

5. The method of claim 4, further comprising delaying the re-transmission of the received packet.

6. The method of claim 5, further comprising:
commencing re-transmission of the received packet at a higher speed after receiving only a portion of the received packet;
re-transmitting the received packet continuously at the higher speed; and
completing re-transmission of the received packet after completely receiving the received packet.

7. The method of claim 1, further comprising:
controlling a cross point to connect the source network section to the destination network section.

8. The method of claim 2, further comprising:
controlling a first cross point to unilaterally connect the destination network section to an interface circuit;
employing the interface circuit to determine whether the destination network section is busy.

9. The method of claim 8, further comprising:
controlling a second cross point to unilaterally connect the source network section to the destination network section if the interface circuit determines that the destination network section is not busy.

10. The method of claim 8, further comprising:
signaling a collision to the source network section if the interface circuit determines that the destination network section is busy.

11. A method for communicating information between a plurality of local area network sections having different transmission speeds, the method comprising the steps of:
a) receiving a packet that is transmitted from a source terminal in a source network section having a source transmission speed to a destination terminal in a destination network section having a destination transmission speed, the destination transmission speed differing from the source transmission speed;
b) determining the transmission speed for the destination terminal;
c) determining whether the destination network section is not busy prior to receiving all of the packet; and
d) re-transmitting the received packet to the destination network section at the destination transmission speed if the destination network section is determined to be not busy.

12. The method of claim 11, wherein the step c further comprises commencing re-transmission of the received packet before the source terminal completes its transmission of the packet.

13. The method of claim 11, further comprising delaying the re-transmission of the received packet.

14. The method of claim 13, further comprising:
commencing re-transmission of the received packet at a higher speed after receiving only a portion of the received packet;
re-transmitting the received packet continuously at the higher speed; and
completing re-transmission of the received packet after completely receiving the received packet.

15. The method of claim 11, further comprising:
controlling a cross point to connect the source network section to the destination network section.

16. The method of claim 11, further comprising:
controlling a first cross point to unilaterally connect the destination network section to an interface circuit;
employing the interface circuit to determine whether the destination network section is busy.

17. The method of claim 16, further comprising:
controlling a second cross point to unilaterally connect the source network section to the destination network section if the interface circuit determines that the destination network section is not busy.

18. The method of claim 11, further comprising:
signaling a collision to the source network section if the destination network section is determined to be busy.

19. An arrangement for switching between a plurality of hubs that employ a plurality of data rates, the arrangement comprising:
a cross point switch having a plurality of ports, each port operably coupled to one of the plurality of hubs, the cross point switch operable to couple a first port to a second port;
a data speed converter operable to receive packet data transmitted from a first hub at a first data rate, the data speed converter operable to re-transmit the packet data to the first port at a second data rate, the second data rate employed by a second hub connected to the second port.

20. The arrangement of claim 19 wherein the data speed converter is further operable to delay re-transmission of the packet data by a time based on a packet length and a difference between the first data rate and the second data rate.
